(19) United States
(12) Patent Application Publication
(10) Pub. No.: US 2002/0171868 A1
(43) Pub. Date: Nov. 21, 2002

(54) Print control apparatus and print instruction apparatus

(75) Inventors: Toshihide Yoshimura, Kawasaki-shi (JP); Hiromi Ohara, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/143,018

(22) Filed: May 13, 2002

(30) Foreign Application Priority Data
May 15, 2001 (JP) 2001-144896
Apr. 26, 2002 (JP) 2002-126667

(51) Int. Cl. G06F 15/00; G06F 3/12; G06F 13/00; G06F 12/00

(52) U.S. Cl. 358/1.15; 358/1.16

(57) ABSTRACT

A print server temporarily stores into a spooler, print data contained in print jobs, which are accepted from scanners and clients. The print server also outputs a portion of the print data as a sample print and the remaining print data thereof as a final print when the print jobs are executed in accordance with a predetermined condition.

The present disclosure relates to a subject matter contained in Japanese Patent Application No.2001-144896 filed on May 15, 2001, which is incorporated herein by reference in its entirety.

### BACKGROUND OF THE INVENTION

1. Field of the Invention

The present invention generally relates to a print control apparatus and a print instruction apparatus. More specifically, the present invention is related to both a print control apparatus for performing a sample printing (test printing) operation and a print instruction apparatus for issuing a print instruction to perform a sample printing operation under such a network environment that a plurality of printing apparatus are connected to each other.

2. Description of the Related Art

In the case that a printing apparatus prints out a document to obtain a plurality of printed copies thereof, the following printing process is normally carried out. That is, only a portion of these plural printed sheets is firstly printed out as a sample print. After a result of sample printed sheets is confirmed, the remaining sheets of this document are printed by the printing apparatus. Various printing apparatus having a function capable of supporting the above-described printing process operation have been proposed.

However, in most of such printing apparatus capable of performing the sample printing operation, a next print request cannot be accepted by these printing apparatus under such a condition that the printing apparatus wait for the printing operation of the remaining document sheets after the sample printing operation has been carried out. As a result, there is such a case that other host computers and a user must wait for executions of next printing operations.

To solve this problem, Japanese Laid-open Patent Application No. 2000-172477 has proposed “PRINTER APPARATUS.” In this printer apparatus, the next print request is received and the image data is stored during the waiting time after the trail printing operation has been performed. In the case that the printed sheets are not outputted to the same paper output tray or stacker, this printer apparatus executes the printing operation. Furthermore, in such a case that the sample printing operation is set, the printer apparatus executes this sample printing operation with a top priority so as to reduce the waiting states of other host computers and the user.

On the other hand, when a sample printing operation is carried out, there are some possibilities that output results of this sample printing operation cannot be satisfied by users. In this case, a sample printing operation is again carried out. A process method for retrying a printing operation is known from, for example, “IMAGE FORMING SYSTEM” described in Japanese Laid-open Patent Application No. 2000-349949. In this image forming system, the print job is deleted after the sample printing operation is carried out. Another process method has been proposed in which a designation of an output method may be changed, for instance, a perfect (duplex) printing method is changed into a single plane-printing method.

However, in the above-described “PRINTER APPARATUS” described in Japanese Laid-open Patent Application No. 2000-172477, the storage limitations are made to store the page images and also to expand the pages of the print data in this printer apparatus.

In the case that the printed sheets are outputted from the same paper output tray or stacker, some of print jobs are brought into the waiting state.

Also, in such a case that the printer apparatus accepts a plurality of sample printing operations as to similar documents, the user can hardly discriminate the relevant sample printing operation from these plural sample printing operations.

This printer apparatus still owns the above-explained problems.

The following technical idea may be conceived. That is, such a process method as described in “IMAGE FORMING SYSTEM” of Japanese Laid-open Patent Application No. 2000-349949 is used in a network environment to which a plurality of printing apparatus are connected, while this process method may delete the print job of the unsatisfied printed output after the sample printing operation has been carried out. However, this technical idea is not suitable for such a distributed printing technique using a merit of a network environment, since only one printing apparatus is designed as the output destination in this technical idea.

Furthermore, in the prior art, in such a case that the sample printing operations are carried out by using a plurality of printers, since the characteristics of the respective printers are different from each other, even when the same original is printed out, such a case may be conceived that the printing qualities of the printed sheets obtained from the respective printers are made different from each other. Also, when the same original is printed out by the plural printers, since the processing conditions of the respective printers are different from each other, such a case may also be conceived that the sample printing operations are not always accomplished at the same time.

As a consequence, the present invention has an object to provide such a print control apparatus, by which under such a network environment to which a plurality of printing apparatus are connected, a sample printing function corresponding to a distributed printing operation can be realized, and a document reprinting operation can be realized. Also, in such a case that a sample printing operation is carried out under such an environment that print data are outputted to a plurality of printers, fluctuations contained in printed qualities which are outputted from the respective printers can be confirmed. Also, the sample printing operation can be carried out in a high efficiency in response to process conditions of the respective printers.

### SUMMARY OF THE INVENTION

In order to achieve the above-described objects, according to a first aspect of the invention, there is provided a print control apparatus for executing a print job and outputting the print job to at least one of a plurality of output destinations connected thereto through a network, the print control apparatus having job accepting means for accepting the print job; temporary storage means for temporarily storing thereinto print data contained in the print job; data converting means for converting the print data stored in the temporary storage means into output data corresponding to the output destination; and output managing means for outputting a portion of data of the output data as first output data and for outputting at least the remaining data of the output data as second output data in accordance with a predetermined condition.

According to a second aspect of the invention, the output managing means outputs the second output data at a previously designated time.

According to a third aspect of the invention, the output managing means outputs the second output data at a time when a user instructs to output.

According to a fourth aspect of the invention, the temporary storage means discards the print data when the user does not issue the data output instruction for a predetermined time duration.

According to a fifth aspect of the invention, the output managing means outputs the first output data to the output destination by user instruction and outputs the second output data to the other (or the same) destination by user instruction. The second instruction has the destination independent of the first data.

According to a sixth aspect of the invention, the output destination is one of a printing apparatus, a file server, and a mail server.

According to a seventh aspect of the invention, there is provided the print control apparatus according to the first aspect, further having print data combining means for combining a plurality of print data with each other, which are temporarily stored in the temporary storage means.

According to an eighth aspect of the invention, there is provided the print control apparatus according to the first aspect, further having print data extracting means for extracting a portion of the print data which is temporarily stored in the temporary storage means.

According to a ninth aspect of the invention, there is provided the print control apparatus according to the first aspect, further having print data editing means for replacing at least a portion of first print data contained in a first print job, which is temporarily stored in the temporary storage means, with at least a portion of second print data contained in a second print job.

According to a tenth aspect of the invention, a print instruction apparatus applied to a print system, connected via a network to a plurality of printers, the print instruction apparatus having number-of-output-copy accepting means for accepting an input of a number of output copy; sample printing operation instructing means for instructing a plurality of printers to execute a sample printing operation; and final printing operation instructing means for selecting a printer to instruct the selected printer to execute a final printing operation.

According to an eleventh aspect of the invention, there is provided the print instruction apparatus according to the tenth aspect, further having printer display means for displaying at least one printer, which the sample printing operation instructing means and the final printing operation instructing means can instruct to execute the printing operation.

According to a twelfth aspect of the invention, the printer display means displays the printer, which can be instructed to execute the printing operation, together with attribute information of the printer.

According to a thirteenth aspect of the invention, the printer display means comprises extract condition accepting means for accepting an input of a condition used to extract a printer and the printer display means displays a printer extracted based upon the condition accepted by the extract condition accepting means.

According to a fourteenth aspect of the invention, the final printing operation instructing means displays job identification information for identifying a print job executed in response to the sample printing instruction by the sample printing operation instructing means.

According to a fifteenth aspect of the invention, the final printing operation instructing means selects a print job corresponding to the job identification information.

According to a sixteenth aspect of the invention, the final printing operation instructing means displays printer information of a printer which is instructed to execute the printing operation by the print job corresponding to the job identification information.

According to a seventeenth aspect of the invention, the printer information is information used to identify the respective printers.

According to an eighteenth aspect of the invention, the printer information is condition information indicative of conditions of the respective printers.

According to a nineteenth aspect of the invention, there is provided a print control apparatus for executing a print control with respect to a plurality of printers connected to a network in accordance with a printing instruction issued from a client connected thereto via the network, the print control apparatus having sample printing job accepting means for accepting a sample printing instruction issued from the client with respect to the plurality of printers; sample printing job producing means for producing print jobs to be processed in the printers designated by the sample printing instruction based on the sample printing instruction accepted by the sample job accepting means; sample printing information managing means for storing thereinto one of the sample printing instruction accepted by the sample printing job accepting means and the plurality of the print jobs produced by the sample printing job producing means to manage the one; and sample printing job requesting means for transmitting the plurality of print jobs produced by the sample print job producing means to the printers corresponding thereto.

According to twentieth aspect of the invention, there is provided the print control apparatus according to the nineteenth aspect, further having sample printing job holding means for holding the print job requested by the sample printing job requesting means.

According to a twenty-first aspect of the invention, the sample printing information managing means stores thereinto printer information of the printers designated by the sample printing instruction accepted by the sample printing job accepting means in combination with the one of the sample printing instruction and the print job.

According to a twenty-second aspect of the invention, there is provided The print control apparatus according to the nineteenth aspect, further having sample printing information output means for outputting the one of the sample printing instruction and the print job, which is managed by the sample printing information managing means.

According to a twenty-third aspect of the invention, the sample printing job producing means produces print jobs to which identification information are added with respect to the plural printers, respectively the identification information is used to identify the printers designated by the sample printing instruction.

According to a twenty-fourth aspect of the invention, there is provided the print control apparatus according to the nineteenth aspect, further having identification information outputting means for outputting identification information used to identify the printers connected to the network.

According to a twenty-fifth aspect of the invention, the identification information is a printer name of the printer.

According to a twenty-sixth aspect of the invention, the identification information is positional information of the printer.

### BRIEF DESCRIPTION OF THE DRAWINGS

Exemplary embodiments will be given with reference to the drawings, in which like reference numerals represent like parts, and wherein

FIG. 1 is a block diagram for indicating an arrangement of a document processing system to which the present invention is applied;

FIG. 2 is a diagram for representing a functional structure of a print server 1;

FIG. 3 is a figure (1) for indicating an operation example of the print server 1;

FIG. 4 is a figure (2) for showing an operation example of the print server 1;

FIG. 5 is a figure (3) for indicating an operation example of the print server 1;

FIG. 6 is a figure (4) for showing an operation example of the print server 1;

FIG. 7 is a figure (5) for indicating an operation example of the print server 1;

FIG. 8 is a figure (6) for showing an operation example of the print server 1;

FIG. 9 is a schematic diagram showing a functional arrangement of a print server according to an embodiment 2;

FIG. 10 is an example of a print instruction initial screen;

FIG. 11 is a flow chart indicating a process flow operation executed when the sample printing operation is instructed;

FIG. 12 is an example of a sample print job list screen;

FIG. 13 is an example of a new sample print screen;

FIG. 14 is an example of an output destination printer selection screen;

FIG. 15 is an example of a detailed display screen;

FIG. 16 is a flow chart (1) indicating flow of the sample printing process operation by the print server 100;

FIG. 17 is a flow chart (2) indicating flow of the sample printing process operation by the print server 100;

FIG. 18 is a flow chart (3) indicating flow of the sample printing process operation by the print server 100;

FIG. 19 is an example of a sample print table;

FIG. 20 is an example of a print process condition management table;

FIG. 21 is an example of a condition confirmation screen; and

FIG. 22 is an example of a print result of the sample printing operation.

### DETAILED DESCRIPTION OF THE EMBODIMENTS

Referring now to drawings, both a print control apparatus and a print instruction apparatus according to embodiments of the present invention will be described.

[Embodiment 1]

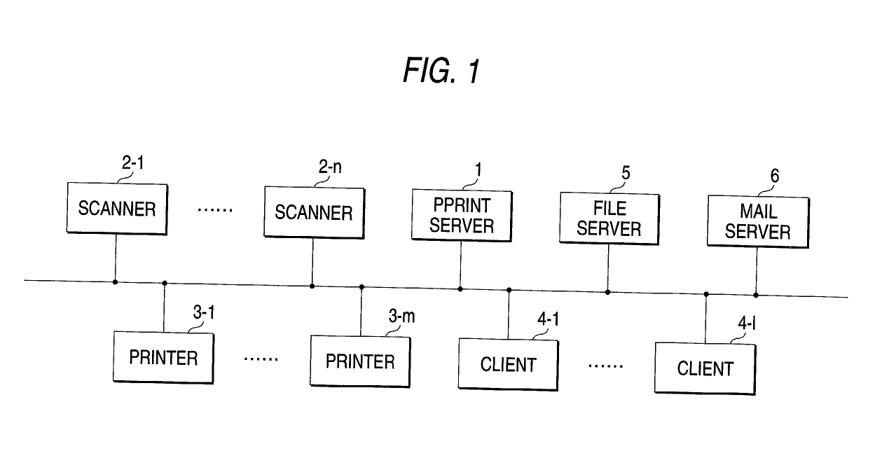

FIG. 1 is a block diagram for indicating an arrangement of a document processing system to which the present invention is applied. As indicated in this drawing, the document processing system has a print server 1, a scanner 2 (2-1 to 2-n), a printer 3 (3-1 to 3-m), a client 4 (4-1 to 4-l), a file server 5, and a mail server 6, which are connected to a network.

The print server 1 executes and manages various sorts of processing operations defined from an acceptance of a printing job up to an output of the printing job. The scanner 2 reads out an original to output image data. The printer 3 forms an image on paper based upon print data such as image data. The client 4 uses application software, and outputs print data to the print server 1. The file server 5 stores thereinto a file. The mail server 6 transmits and receives a mail.

It is noted that both the scanner 2 and the printer 3 may be alternatively realized by a single apparatus equipped with both scanner/printer functions. Alternatively, the print server 1, the file server 5, and the mail server 6 may be arranged on the same workstation (PC). Also, this document processing system may be arranged in such a manner that the document processing system is connected via a gateway (not shown) to another network.

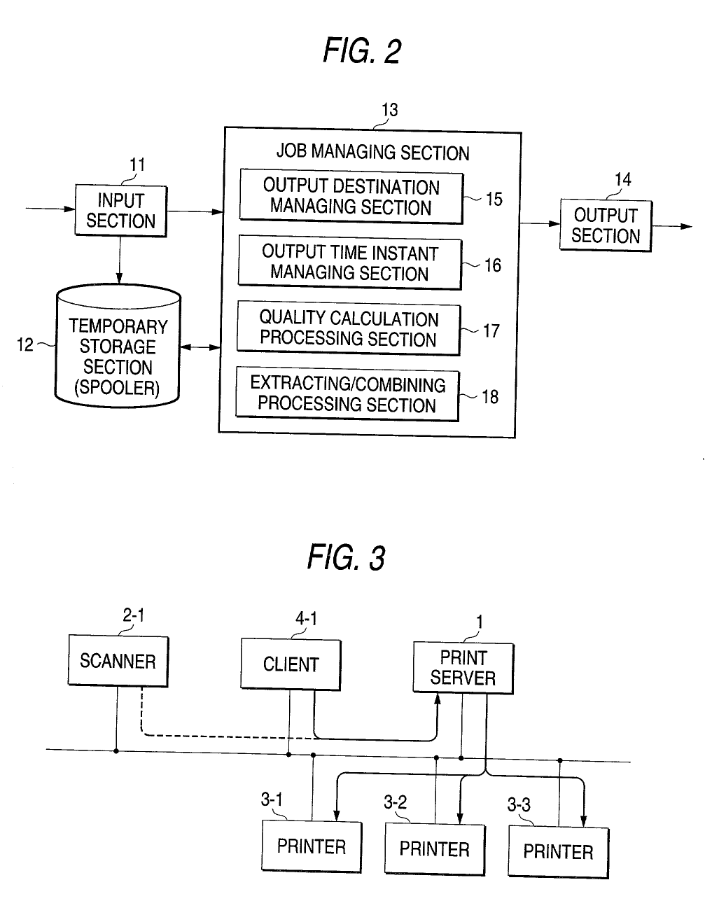

Next, the print server 1 will now be explained. FIG. 2 is a diagram for illustratively showing a functional arrangement of the print server 1.

As indicated in this drawing, the print server 1 has an input section 11, a temporary storage section 12, a job managing section 13, and an output section 14.

The input section 11 accepts a print job, and stores this accepted print job into the temporary storage section 12, and further, notifies such a fact that the print job is accepted to the job managing section 13. As the print job accepted by the input section 11, there are two cases. That is, the input section 11 receives from the scanner 2 such a notification that an image is read out, and then acquires an image in response to this notification (normally, image has been stored in file server 5). Also, the input section 11 receives print data which is produced by a printer driver of the client 4.

The temporary storage section 12 temporarily stores thereinto print data, and is generally referred to as a “spooler.” The job managing section 13 executes various sorts of managements related to an execution of a job, the detailed content of which will be explained later. The output section 14 outputs such a print data which is acquired from the temporary storage section 12 by the job managing section 13 to an output destination designated by the job managing section 13.

Now, a detailed description will be given on the job managing section 13.

The job managing section 13 executes such a process operation that a portion of print data is outputted as a sample print (test print), and after a user confirms an output result of this sample print, the remaining print is carried out. As this sample print, one copy of a plurality of printed copies are outputted, and/or a partial document contained in a document made of a large number of pages is outputted. To realize such a sample printing operation, the job managing section 13 is provided with an output destination managing section 15, an output time instant managing section 16, a quantity calculation processing section 17, and an extracting/combining processing section 18.

The output destination managing section 15 cancels a print job and changes an output destination based upon an instruction issued from a user (namely, issued from either UI (User Interface) of scanner 2 or client 4). When the print job is canceled, the output destination managing section 15 deletes the print job itself and deletes the print data stored in the temporary storage section 12. The output destination managing section 15 may change the output destination in the unit of a print job. Further, the output destination managing section 15 may arbitrarily change the output destination so that a sample printing (test printing) operation is performed by one output destination and a final printing operation are performed by another output destination. The final printing operation may be performed for remaining print data except for data of sample printing operation is printed.

As the output destination, the printers 3-1 to 3-m, the file server 5, and the mail server 6 are employed. In the case that the printers 3-1 to 3-m are designated as the output destination, the output destination managing section 15 outputs such a print data having a printing format which can be processed by the designated printers (3-1 to 3-m) to these designated printer. In the case that a file folder is designated as the output destination, the print data is stored into a designated folder of the file server 5 as a reprint file. Also, in the case that a mail address is designated as the output destination, the output destination managing section 15 forms an electronic mail addressed to this mail address, and attaches print data to the formed electronic mail so as to send the attached mail to the mail server 6.

The output time instant managing section 16 executes a process operation by which either the normal printing operation or both the sample printing/final printing operations is brought into a held state until a designated time instant has passed. Also, the output time instant managing section 16 executes another process operation by which either the normal printing operation or both the sample printing/final printing operations is brought into a wait state until an instruction is issued from a user. When the output time instant managing section 16 executes the execution waiting process until the instruction is issued form the user, this output time instant managing section 16 sets the term of validity to the acceptance of this user instruction. In the case that the instruction is not issued form the user within the validity term, this output time instant managing section 16 also executes such a process operation that canceling of this print job to the output destination managing section 15 is instructed.

The quantity calculation processing section 17 calculates number of printed copies every output destination based upon an instruction content of a sample printing operation, and also calculates number of printed copies by a final printing operation in response to an instruction made by a user who has checked an output result of a sample printing operation. As a process content of printing operation to a plurality of printers, there are a “number-of-copies equal division process”, a “same-printed-copies output process”, and a “number-of-copies designation process”. While the quantity calculation processing section 17 receives any of these instructions from the user, this quantity calculation processing section 17 calculates a number of printed copies for the respective output destinations in response to this instruction. The number-of-copies equal division process implies that printing outputs themselves are subdivided to a plurality of output destinations. For example, a job made of plural printed sheets is outputted to a plurality of output destinations by subdividing the total printed sheets, so that the printed sheets can be outputted in a high efficiency. The same-printed-copies output process implies that the print output of the same number of printed copies is sent to a plurality of output designations. The number-of-copies designation process implies that number of printed copies are separately designated with respect to a plurality of output destinations. Also, there is such a case that a sample printing operation is once carried out, and a user checks an output result, and thereafter, an output destination of printed sheets is changed. Under this condition, when a sample printing operation is again required, the quantity calculation processing section 17 calculates a necessary quantity of printed sheets in this sample printing operation. When a number of printed copies during a final printing operation is calculated, a total number of remaining copies to be printed is calculated based upon a total number of printed copies in the case that the sample printing operation is finally executed. In other words, when the final printing operation is carried out, the quantity calculation processing section 17 calculates a number of printed copies during the final printing operation based upon such information as to “total number of printed copies”, “printers set as output destinations,” output method (same-printed-copies output, number-of-copies equal division, etc.), “printed sheets are properly outputted by using which printer during sample printing operation” and so on. It is understood that the quantity calculation processing section 17 calculates output-starting pages, not a total number of printed copies in such a case that a portion of a document made of multiple pages is executed as the sample printing operation.

The extracting/combining processing section 18 inserts another print data (namely, print data which is newly read by scanner 2, or is formed by client 4) into such print data stored in the temporary storage section 12. Also, the extracting/combining process section 18 replaces the above-described print data with each other, and also combines a plurality of print data with each other. As the print data to be combined with each other, there are the print data stored in the temporary storage section 12, and the reprint file stored in the file server 5, and so on. Also, this extracting/combining process section 18 extracts partial print data from print data, and then, sends this extracted partial print data to such an output destination which is designated by the output destination managing section 15.

Next, a process operation of a sample printing (test printing) operation in response to a selection of a printer for performing this sample printing operation, which is made by a user, will now be described.

The user designates and selects various information via the client 4 with respect to data which is wanted to be printed out, a total number of copies which are wanted to be printed out, at least one set of printer 3 functioning as an output destination, an output method executed in this selected printer, and also at least one set of printer by which a sample printing operation is wanted to be performed. As the separately selected output methods in a plurality of printers, the above-described various methods are provided, namely, the “number-of-copies equal division” method, the “same-printed-copies output” method, the “number-of-copies designation” method, and the “automatic selection” method.

As the method for designating the output destination of the sample printing operation, since the user separately selects a desirable printer, the user can designate the output designation (selected printer) of this sample printing operation.

It should be noted that the method of designating the output designation of the sample printing operation is not limited only to the above-explained designation method. For instance, the sample printing operation may be alternatively carried out by using all of such printers which are designated as the designation outputs. Since the sample printing operations are carried out by all of these printers, the user can check print results outputted from all of these printers. As a result, even when there is a fluctuation in the print results obtained among these printers, such a printer which cannot satisfy a desirable printing quality is deleted from the printers which are used in the final printing operation.

Alternatively, while a selection may be made of such a printer in which a printing operation is completed at the fastest stage among plural printers which are designated as output destinations, a sample printing operation may be carried out by this selected printer. Also, while the print server 1 may manage conditions of the respective printers, either a printer which does not presently perform a printing operation or such a printer having the lowest load may be selected from printers which are designated as output destinations, and then, the selected printer may execute such a sample printing operation. In this alternative case, a result of the sample printing operation may be acquired at the earliest stage.

Furthermore, when there are plural sets of printers having the same attributes among a group of output destination printers, one printer of these sub-group printers may execute a sample printing operation. For example, in the case that such a designation method “sample printing operation is executed by single color printer and single monochrome printer” is set, when an original is outputted in which color data and monochrome data are mixed with each other, a user may effectively check a difference between image qualities of print output results as to the same original, which are obtained from both the color printer and the monochrome printer.

As previously explained, the output destination information of the sample printing operation, which is designated by the client 4, is transmitted to the print server 1. Then, the output destination managing section 15 of the print server 1 controls the output destinations of the sample printing operation based upon this information.

Next, a description will now be made of such a final printing operation performed after a sample printing operation has been carried out by a printer designated by a user and then these print output results are checked.

The user checks the print output result obtained during the sample printing operation, and then, issues an instruction related to the final printing operation via the client 4 based upon the checked result.

With respect to the final printing operation, the user is capable of instructing an instruction of “print remaining data”, and another instruction of “execute re-sample-printing-operation.” In the case that a result of a sample printing operation is proper, if the user instructs “print remaining data” via the client 4, then the print server 1 controls the respective printers to output printed copies whose total numbers are obtained by subtracting the number of the printed copies outputted as the sample printing operation from such total numbers allocated to the respective printers.

On the other hand, in such a case that a condition of a printer is deteriorated and/or an original is replaced by a new original due to some problems, when the user judges that the result of the sample printing operation is improper, if the user instructs “execute re-sample-printing-operation” via the client 4, then the print server 1 controls such a printer which is instructed to execute the re-sample-printing-operation to again execute a sample printing operation.

The quantity calculation processing section 17 of the print server 1 calculates total numbers of printed copies outputted from the respective printers, and controls the respective printers to output the calculated total numbers of printed copies based upon both the various designation information and another information defining as to whether or not the sample printing operations are carried out in the respective printers. The designation information corresponds to such information capable of instructing the printing methods of “number-of-copies equal division”, “same-printed-copies output”, and “number-of-copies designation”, which is instructed by the user via the client 4 before the sample printing operation is carried out. Also, the designation information corresponds to “print remaining data” and “execute re-sample-printing-operation”, which are designated when the final printing operation is executed.

Also, as a result of this sample printing operation, when the final printing operation is carried out, the user newly may select a printer as an output destination, and also, may designate any of these printing methods of “number-of-copies equal division”, “same-printed-copies output”, and also, “number-of-copies designation.”

As to the previously-explained instructions of “print remaining data” and “execute re-sampleprinting-operation”, the document processing system may be arranged in such a manner that all of printers designated as the output destinations may be instructed in a batch mode, or the individual printers may be instructed.

Alternatively, the document processing system may be arranged in such a manner that as a result of this sample printing operation, the final printing operation is instructed only to one printer of these printers, the printing quality of which is the superlative quality.

Also, when an output destination printer is changed as a result of such a sample printing operation, the document processing system may be arranged in such a manner that the sample printing operation is automatically carried out.

Furthermore, in the case that print data stored in the file server 5 is again outputted, when the output destination managing section 15 changes an output destination in such a manner that this print data is outputted to a printer which is different from such a printer to which this print data has been outputted in the previous time, the document processing system may be arranged in such a way that a sample printing operation is automatically carried out.

Alternatively, the document processing system may be arranged in such a manner that a user who views a result of checking a print output of a sample printing operation instructs to change printing attributes.

For example, as a result of such a sample printing operation, when a changing instruction of printing attributes is issued from the client 4, the print server 1 changes the printing attributes with respect to a print job under SPOOL state. In this case, the print server 1 changes the printing attributes with respect to jobs for a plurality of output destinations in a batch mode. Since the document processing system is constituted in the above-described manner, as a result of printed outputs in the sample printing operation, in the case that a stapled position is different from the intended position, or in the case that a destination of fonts are different from the intended fonts, since the output result is changed by merely changing the attributes without resending of the print data, a desirable printing output result may be obtained.

Also, as to the change of the print attributes, the document processing system may be arranged in such a manner that as a result of a sample printing operation, attributes may be separately set with respect to such printers which do not output intended print outputs. When changing of the print attributes is instructed from the client 4 to the respective printers, while a job is transmitted to the designated printer, the print attributes are changed in the print sever 1. Thereafter, the changed print attributes are transmitted to the output destination printer. Since the document processing system is arranged in accordance with the above-described manner, the following problem may be solved by individually changing the stapled positions. That is, in the case that the printed results are outputted by a plurality of printers, when an instruction is issued in such a manner that a staple process operation is carried out at the same positions, the staple process operation is made at different positions. This problem is caused by differences of post-processing apparatus provided in these plural printers. Similarly, in the case that the fonts equipped in the respective printers are different from each other, the problem may be solved in a similar manner.

Also, the document processing system may be arranged in such a manner that when a change of such print attributes is instructed, such an instruction as to whether or not a sample printing operation is required is instructed at the same time, or the sample printing operation is automatically carried out.

Referring now to FIG. 3 to FIG. 8, an example of operations of the print sever 1 will be explained. FIG. 3 to FIG. 8 are diagrams for indicating examples as to respective operations of the print server 1.

First, the following assumption is made (see FIG. 3). That is, 10 copies of print data in total are outputted from the printers 3-1, 3-2, and 3-3, while these print data are produced by the client 4-1, or are acquired by reading an image by the scanner 2-1. Furthermore, in the case that “number-of-copies equal division” is designated as the output method, the printers 3-1 and 3-2 are designated as the sample printing operation. In this case, the print results of the sample printing operation are outputted from the printers 3-1 and 3-2 one by one. Thereafter, when the final printing operation is instructed, the printer server 1 equally divides such a value obtained by subtracting total number of printed copies by number of printed copies during the sample printing operation by a total number of output destinations, the printed copies are outputted every three copies from the printers 3-1 and 3-2, and the printed copies are outputted two copies from the printer 3-3. It should be noted that when three copies of printed outputs in total are designated, only one copy thereof is outputted from the printer 3-3 in the final printing operation.

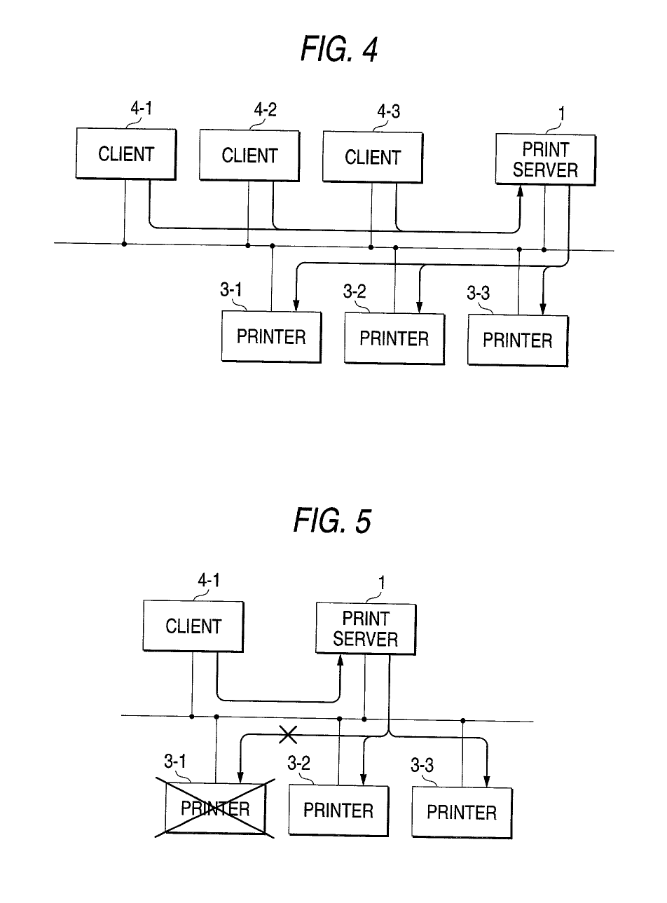

Also, in such a case that print jobs are issued from the clients 4-1, 4-2, 4-3 at the substantially same time (see FIG. 4), the print server 1 sequentially accepts the print jobs and queues the accepted print jobs, and also stores the print data into a spooler (temporary storage section 12). As a result, in the clients 4-1, 4-2, and 4-3, issuing operation of the print jobs is not waited.

Also, in such a case that although a print job containing an instruction of a sample printing operation by the printer 3-1 is issued, a toner empty occurs in this printer 3-1 and therefore a satisfactable printing result cannot be obtained, and then such an instruction is issued so as to execute a final printing operation from the printers 3-2 and 3-3 (see FIG. 5), if no sample printing operation is carried out, then a half number of total number of printed copies are outputted from each of these printers 3-2 and 3-3. Then, when a sample printing operation is again carried out, the respective printers 3-2 and 3-3 output a half number of entire printed copies which are obtained by subtracting a total number of the printed copies by the sample printing operation from a total number of printed copies during the final printing operations.

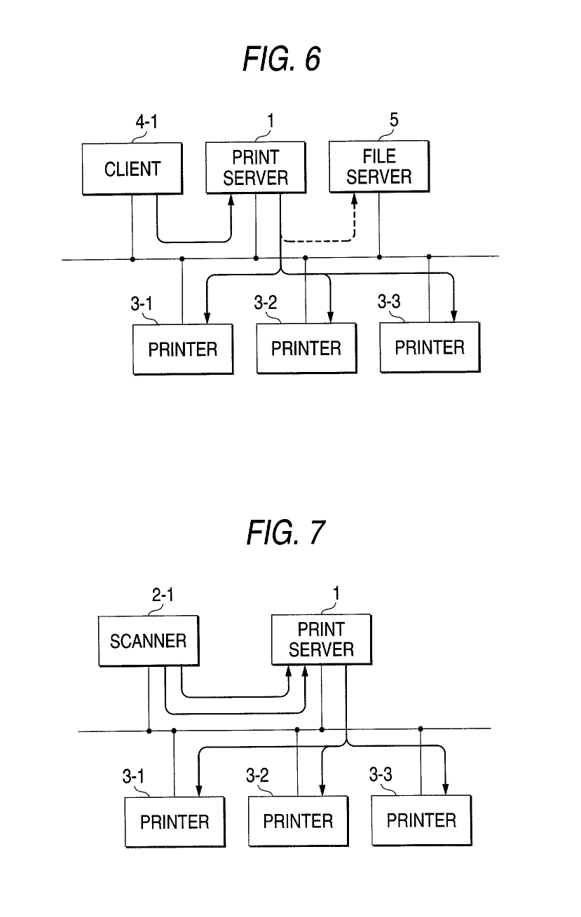

Also, in such a case that the sample printing operation by the printer 3-1 is instructed while the final printing operations by the printers 3-1, 3-2, 3-3 are scheduled (see FIG. 6), it is so assumed that the user views the output result of the sample printing operation and reschedules the execution of the final printing operation at a different chance. In this assumption case, when the output destination is changed from the printers 3-1, 3-2, 3-3 into the file server 5, the print data is stored into the file server 5 as a reprint file.

Also, another assumption is made (see FIG. 7). That is, while images of originals read out by the scanner 2-1 are scheduled to be outputted from the printers 3-1, 3-2, and 3-3, a sample printing operation is carried out by the printer 3-1, so that a portion of an original is mistakenly read out by the scanner 2. In this assumption case, only such an original which has been mistakenly read out by the scanner 2 is again read, and a sample printing operation is again carried out. Then, if a printing result of this sample printing operation can be satisfied, then the final printing operation may be carried out.

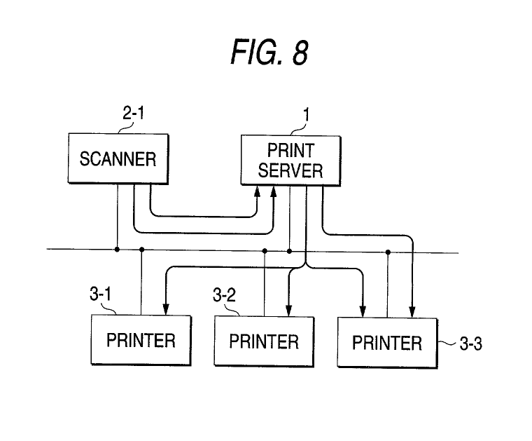

Also, another assumption is made (see FIG. 8). That is, while an image read out by the scanner 2-1 is scheduled to be outputted from the printers 3-1, 3-2, and 3-3, a sample printing operation is carried out by using the printer 3-1. As a result, an image disturbance happens to occur in a portion of a page. In this assumption case, the sample printing operation is again carried out by using the printer 3-3 in order to clearly judge as to whether the reason of such an image disturbance is caused by mistakenly reading the image by the scanner 2, or by mistakenly processing the image data in the printer 3-2. Then, if a printing result of this sample printing operation can be satisfied, then the final printing operation may be carried out.

It should be understood that only several examples have been explained as the operation example of the input server 1 in this case. Alternatively, other various process operations may be carried out by combining the above-explained various functions owned by the print server 1 with each other.

[Embodiment 2]

A print server 100 according to an embodiment 2 (described later) may be used in a network shown in FIGS. 1 and 3 to 8, in place of the print server 1.

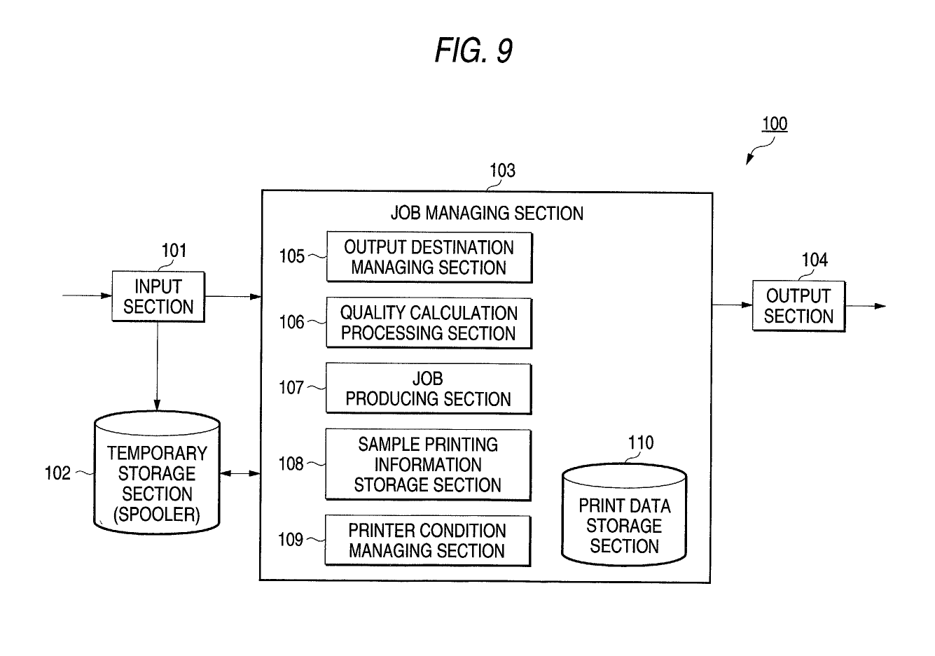

FIG. 9 is a schematic diagram showing a functional arrangement of a print server according to an embodiment 2. As indicated in this drawing, the print server includes an input section 101, a temporary storage section 102, a job managing section 103, and an output section 104.

The input section 101 accepts a print job, and stores this accepted print job into the temporary storage section 102, and further, notifies such a fact that the print job is accepted to the job managing section 103. As the print job accepted by the input section 101, there are two cases. That is, the input section 101 receives such a notification that an image is read from the scanner 2, so that this input section 101 acquires the image in response to this notification (normally, image has been stored in file server 5). Also, the input section 11 accepts print data which is produced by a printer driver of the client 4.

The temporary storage section 102 temporarily stores thereinto print data of the print job. The job managing section 103 executes various sorts of managements related to an execution of a job, the detailed content of which will be explained later. The output section 104 outputs such a print data which is acquired from the temporary storage section 102 by the job managing section 103 to an output destination designated by the job managing section 103.

Now, a detailed description will be given on the job managing section 103.

The job managing section 103 executes such a process operation that a portion of print data is outputted as a sample print (test print), and after a user confirms an output result of this sample printing operation, the remaining print operation is carried out. As this sample printing operation, one copy of a plurality of copies are outputted, and/or a partial document contained in a document made of a large number of pages is outputted. To realize such a sample printing operation, the job managing section 103 is provided with an output destination managing section 105, a quantity calculation processing section 106, a job producing section 107, a sample printing information storage section 108, a printer condition managing section 109, and a print data storage section 110.

The output destination managing section 105 cancels a print job and changes an output destination based upon an instruction issued from a user (namely, issued from either UI (User Interface) of scanner 3 or client 4). The quantity calculation processing section 106 calculates a total quantity of printed copies every output destination based upon an instruction content of a sample printing operation, and also calculates a total quantity of printed copies by a final printing operation in response to an instruction made by a user who has checked an output result of a sample printing operation.

The job producing section 107 produces such a print job as a sample print job and a final print job. The sample printing information storage section 108 stores thereinto information related to a sample printing operation. The print condition managing section 109 manages conditions (states) of the respective printers which constitute output destinations. The print data storage section 110 stores thereinto print data in such a case that a sample print job is executed.

Next, a description will be given on a sample printing process operation using this print server 100.

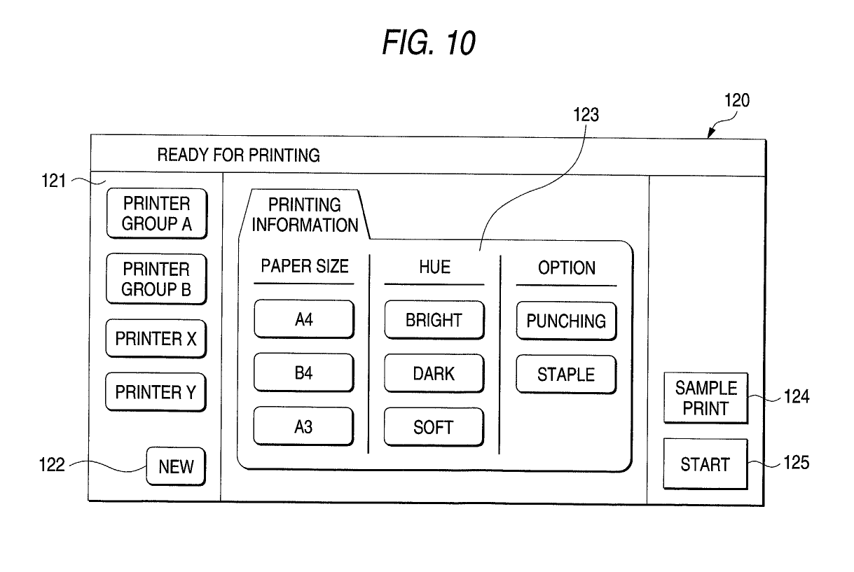

First, issuing operation of a sample printing instruction from the client 4 and the like will now be described. The sample printing operation is instructed via the client 4 and the like. At this time, such a print instruction initial screen 120 as shown in FIG. 10 is displayed by the print server 100 on the client 4 and the like.

As shown in this drawing, a printer list 121, a “new printer select” button 122, an output format setting column 123, a “sample print” button 124, and a “start” button 125 are arranged on this print instruction initial screen 120. The printer list 121 indicates registered printers and printer groups. The “new printer select” button 122 is used to select a printer other than the printers indicated in the printer list 121. The output format setting column 123 is to set an output format. The “sample print” button 124 is used to instruct a start of a sample printing operation. The “start button” 125 is used to instruct the normal printing operation.

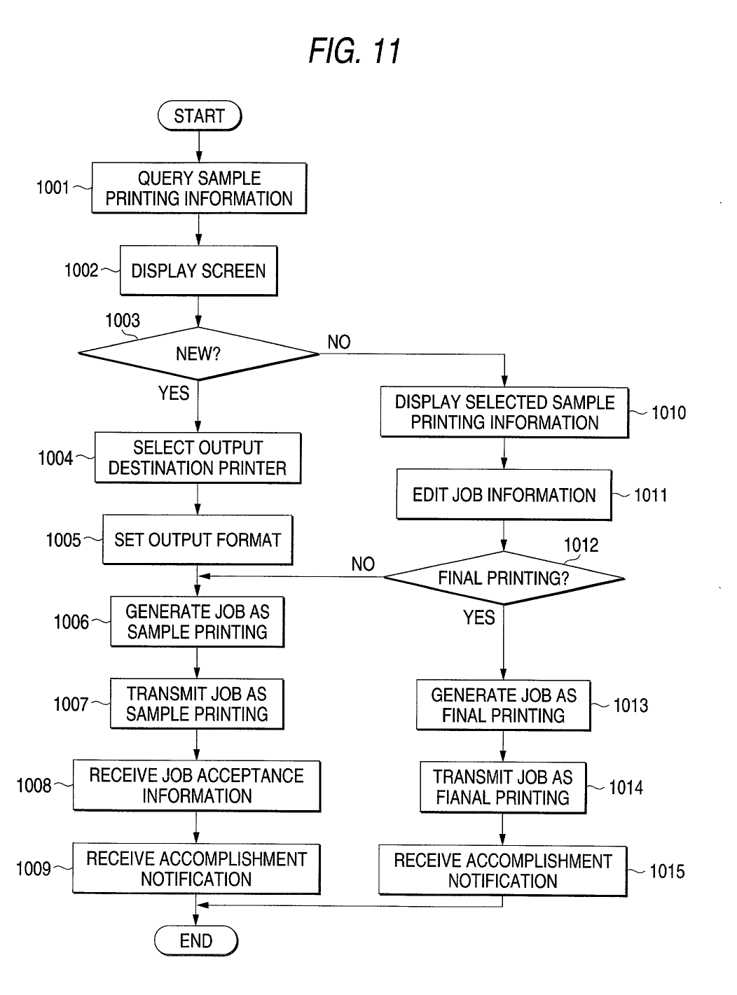

When a user depresses the “sample print” button 124 on this screen 120, a sample printing process operation is commenced. FIG. 11 is a flow chart for describing a process flow operation executed when the sample printing operation is instructed.

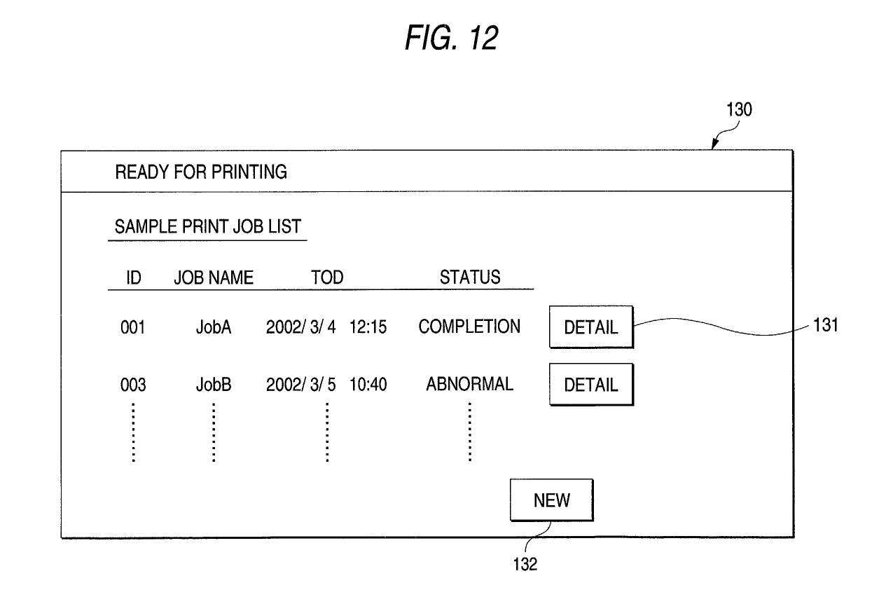

When the “sample print” button 124 is depressed, the client 4 starts an instruction process operation of the sample printing operation. First, the client 4 queries to the print server 100, such sample printing information corresponding to information about a job to which the sample printing operation has already been instructed (step 1001). When the print server 100 returns the sample print information in response to this query, the client 4 displays a sample print job list screen 130 as shown in FIG. 12 based upon this sample print information (step 1002), while this sample print job list screen 130 indicates a list of the jobs to which the sample printing operations have already been instructed.

On this sample print job list screen 130, both a “detail” button 131 and a “new sample printing operation” button 132 are arranged. This “detail” button 131 is employed to confirm a detailed content of each of the jobs to which the sample printing operations have already been instructed. The “new sample printing operation” button 132 is used to newly instruct a sample printing operation.

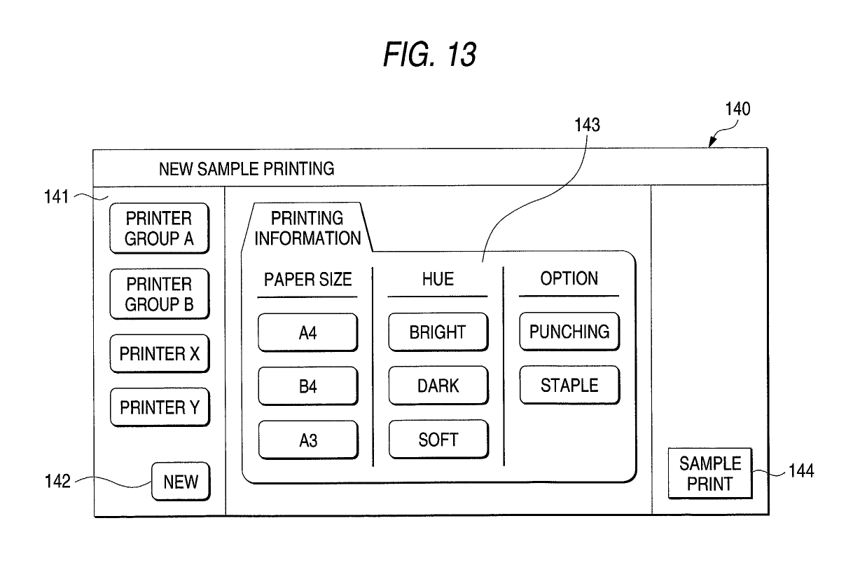

In this case, when the user depresses the “new sample printing operation” button 132 (“YES” in step 1003), a new sample printing screen 140 as shown in FIG. 13 is displayed in the client 4. A printer list 141, a “new printer select” button .142, an output format setting column 143, and a “sample print” button 144 are arranged on this new sample printing screen 140. The printer list 141 indicates registered printers and printer groups. The “new printer select” button 142 is used to select a printer other than the printers indicated in the printer list 141. The output format setting column 142 is to set an output format. The “sample print” button 144 is used to instruct a start of a sample printing operation.

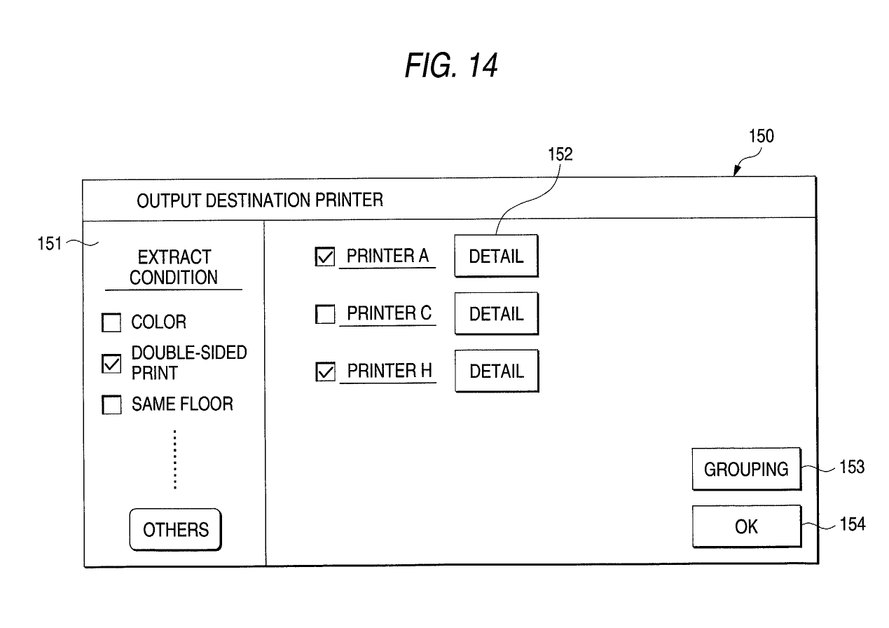

Then, the user selects the printer indicated in the printer list 141, or depresses the “new printer select” button 142 so as to set a printer of an output destination (step 1004). In the case that the user depresses the “new printer select” button 142, such an output destination printer select screen 150 shown in FIG. 14 is displayed. While a printer select condition setting column 151 is arranged on this output destination printer select screen 150, when a select condition of a printer is entered into this printer selection condition setting column 151, such a printer capable of satisfying the select condition is displayed on an extracted printer list 152.

As the select condition to select output destination printers based on a printer attribute and value, a printer attribute and value such as functional select conditions provided in output destination printers, printer conditions, and extract conditions may be employed. Alternatively, plural sets of these conditions of the printer attribute and value may be combined with each other as this select condition of the printer. The functional select conditions contain “color printer/monochrome printer”, “print out speed capable of printing out printed sheets per minute”, “print out resolution”, “image processing functions such as enlarge/compress/rotate/facing of images”, “optional functions such as perfect printing, staple, and punched hole”, and so on. The printer conditions contain “all printers presently capable of printing out”, “printer capable of completing print out within 30 minutes”, and so on. The extract conditions contain information as to installation places of printers such as “printer installed within 30 meters”, “printers located on the same floor”, and the like. Also, the extract conditions cover account information every user such as “printer permitted to user “A” for printing out.”

The user selects a plurality of desirable printers from the printers displayed on the extracted printer list 152. Also under such a condition that a plurality of printers are selected, since a “grouping” button 153 is depressed, the user may form a printer group. Then, when the user depresses an “OK” button 154, setting of an output destination may be defined.

Subsequently, when the user depresses the “sample print” button 144, the client 4 forms a sample print job (step 1006), and then, transmits the formed sample print job to the print server 100 (step 1007). This sample print job is constituted by information related to a client such as a client address and user information; information related to an output format; information related to an output destination printer; information indicative of both print data and a sample printing operation; and information for indicating that a total number of print out is 1 copy.

Also, when the print server 100 accepts the sample print job, since the print server 100 returns sample print job acceptance information, the client 4 receives this sample print job acceptance information, and then, displays this sample print job acceptance information on the screen (step 1008). This sample print job acceptance information contains a sample print job ID, a sample job name, and the like, which correspond to such information discriminable from other sample print jobs, and are issued from the print server 100. As a result, the user can discriminate the sample print job instructed by the own user from other sample print jobs based upon the sample print job name and the sample print job ID under display. Accordingly, the user can easily instruct the final printing operation, and can again instruct the sample printing operation.

Furthermore, the client 4 queries to confirm a sample printing condition with respect to the print server 100 based upon the sample print job ID, so that the client 4 can confirm a printing condition related to the sample printing operation under process.

Then, when the sample printing operations executed in all of the output destinations (namely, designated printers), such an information that the sample printing operations have been ended is notified from the print server 100, and then, the client 4 receives this notification to display such a message that the sample printing operations have been accomplished on the screen (step 1009).

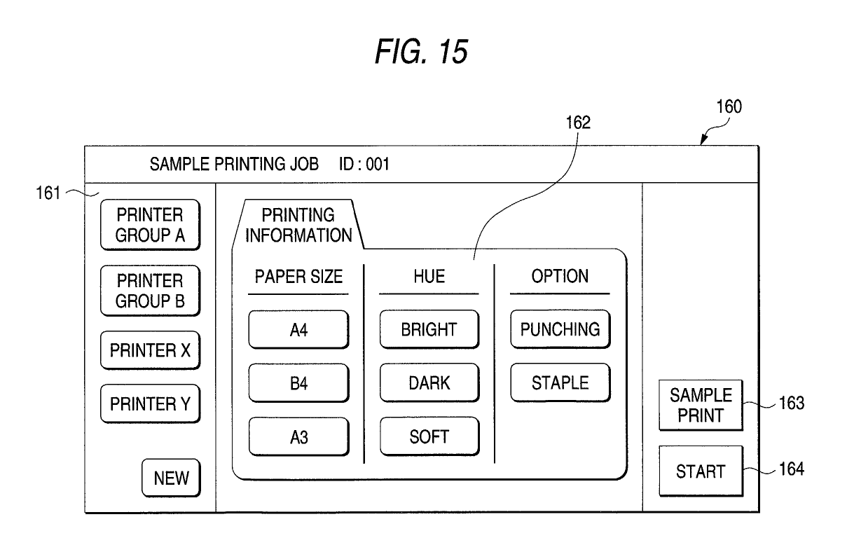

On the other hand, when the user depresses the “detail” button 131 of a desirable job within a list of jobs which the sample printing operations have already been completed and which are displayed on the screen 130 (“NO” in step 1003), such an information related to the previously-instructed sample printing operation is displayed in the client 4. In other words, such an information related to the output destination printers and the output formats, which have been previously instructed, and also process results every output destination printer, for instance, a normal completion and an abnormal completion of the sample printing operation are displayed in the client 4 (step 1010). This indication may be performed by using, for instance, a detailed display screen 160 as shown in FIG. 15.

On this detail display screen 160, a printer list 161, an output format setting column 162, a “sample print” button 163, and a “final print” button 164 are arranged. The printer list 161 displays printers and printer groups. The output format setting column 162 sets an output format. The “sample print” button 163 is used to instruct a commencement of a sample printing operation. The “final print” button 164 is used to instruct a commencement of the final printing operation. Both the printer list 161 and the output format setting column 162 correspond to the above-explained printer list 121 and output format setting column 123 of the print instruction initial screen 120, respectively.

The user considers the displayed printed results of the sample printing operation, and then, may again set the information about the previously-instructed sample printing operation (step 1011). For instance, when the user judges that a printed result obtained from a specific printer is not a desirable printed result, the user may delete the specific printer from the output destination printer information, or may select another output destination printer. Also, when the user checks the printed result to judge that the specific output format is not a desirable result, the user may again set such information related to the output format, for instance, the user may change the font information, may change the stapled position, or may change the color mode.

As a consideration result of the printed results of the sample printing operation, in such a case that the user judges that the printed result corresponds to such a desirable result, or in the case that although the user again sets the information of the output format, the user judges that the sample printing operation is not again carried out (“YES” in step 1012). As a result, the client 4 produces a print job based upon the following information (step 1013), and then, sends the produced print job to the print server 100 (step 1014). This information contains, for example, the sample printing job ID, the information as to the set output destination printer, the output format information, and a distribution output mode such as a total number of output copies, and a number-of-copies equal division/same-printed-copies output.

Then, when the final printing operation is completed by the printers of all of the output destinations, such an information that the final printing operation is accomplished is notified from the print server 100, and then, the client 4 receives this notification so as to display such a message that the final printing operation is accomplished on the screen (step 1015).

Also, after the user again has set the information as to the output format, in the case that the user judges that the sample printing operation is again required to be carried out (“NO” in step 1012), the user depresses the “sample print” button 163 so as to instruct the sample printing operation. As a result, the client 4 produces a sample print job (step 1006), and then, transmits the produced sample print job to the print server 100 (step 1007). It is also noted that in this case, the following control operation may be carried out. That is, such an output destination printer in which a second sample printing operation will be carried out, and furthermore, the setting information such as the output format is not yet changed is removed from the printers designated to the sample printing operations.

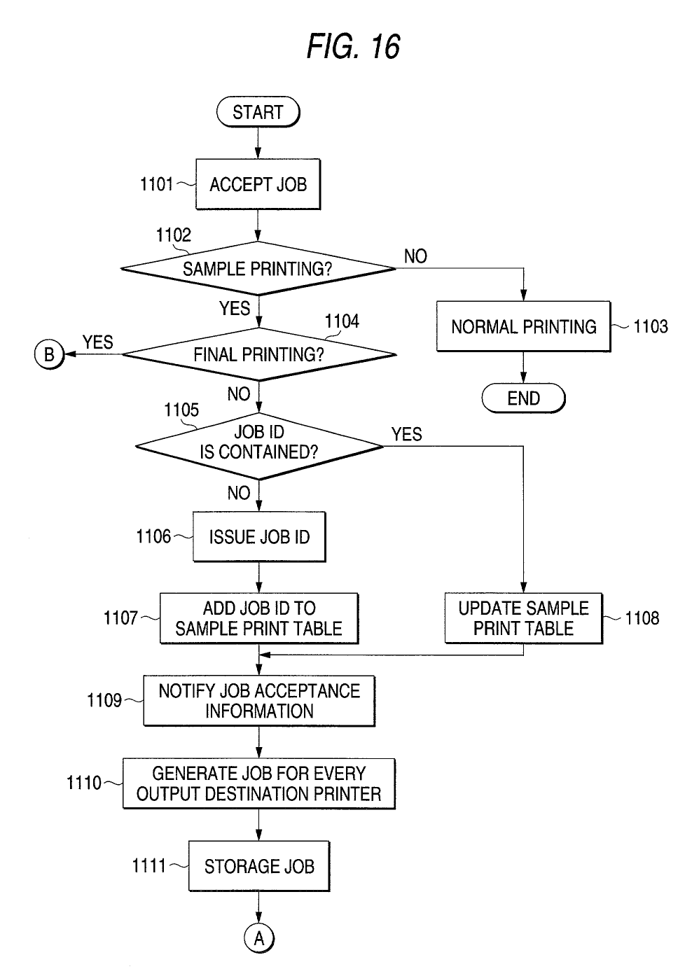

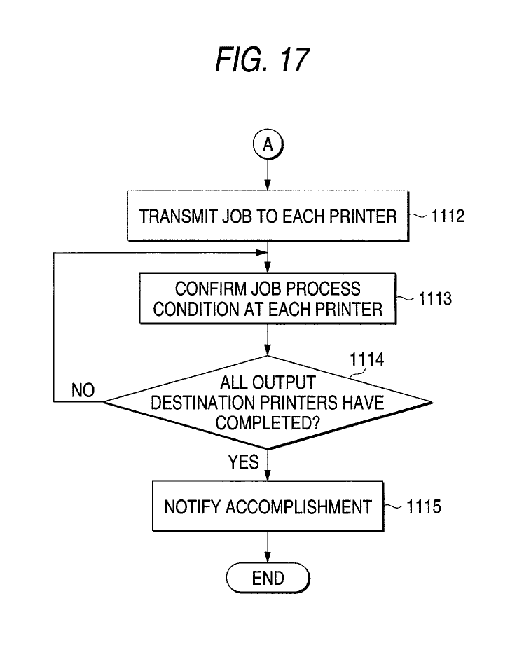

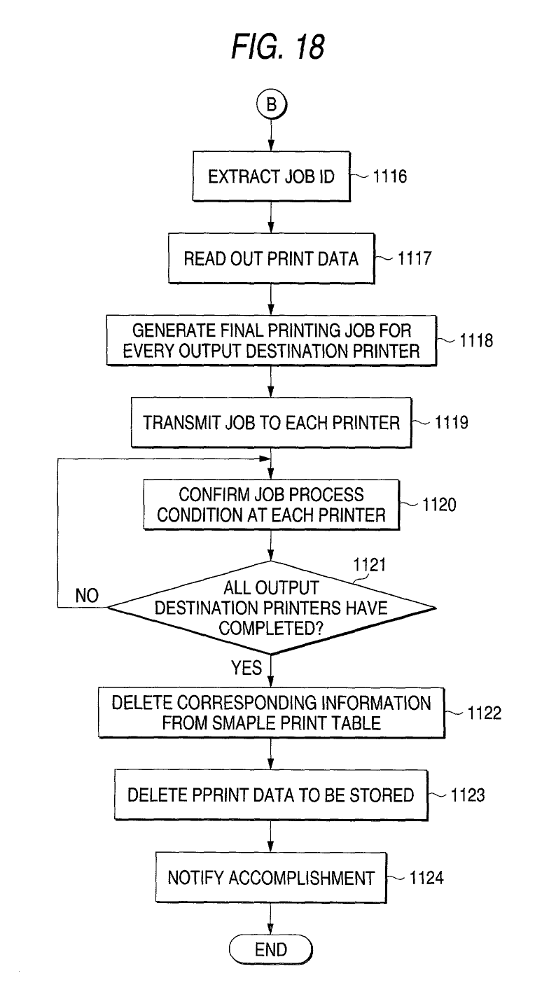

Next, a description will now be given on operations of the print sever 100 in the case that a process operation of a sample print job is carried out. FIGS. 16 to 18 are flow charts for describing flow operations as to the sample printing process operation by the print server 100.

When the print server 100 accepts a print job transmitted from the client 4 (step 1101), the print server 100 confirms as to whether or not this accepted print job contains such an information indicative that this print job corresponds to the sample printing operation.

As a result of this confirmation, if such an information indicative of the sample printing operation is not present in this print job (“NO” in step 1102), then the print server 100 processes the accepted print job as the normal printing process operation (step 1103).

On the other hand, as a result of this confirmation, if such an information indicative of the sample printing operation is contained in the accepted print job (“YES” in step 1102), then the print server 100 confirms as to whether or not such an information indicative of a final printing operation is contained in the accepted print job. If there is no information indicative of the final printing operation (“NO” in step 1104), then the print server 100 judges that this accepted print job corresponds to a sample print job, and furthermore, confirms as to whether or not a sample print job ID is present in the accepted print job.

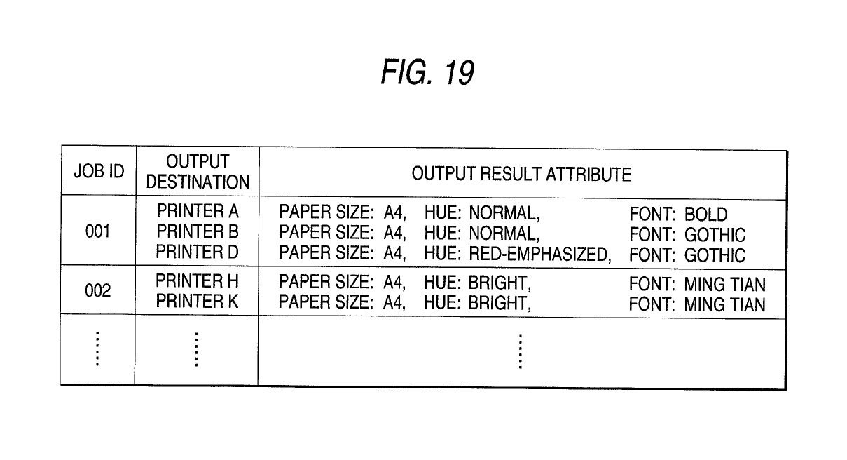

As a result of this confirmation, when the sample print job ID is not contained in the accepted sample print job (“NO” in step 1105), the print server 100 newly issues a sample print job ID, while this accepted sample print job as a new sample print job (step 1106). Then, the print server 100 adds this newly issued sample print job ID into a sample print table stored in the sample print information storage section 108 (step 1107). As represented in FIG. 19, this sample print table corresponds to such a table in which the below-mentioned information is described to be associated with sample print job IDs, namely, information related to printer names of the respective output destination printers, information related to the output destination printers such as ID addresses, and information related to the output formats, and also, information related to sample printing process results obtained in the respective output destination printers.

Also, in the case that the sample print job ID is added to the accepted sample print job (“YES” in step 1105), the print server 100 overwrites both the information as to the output destination printer and the information related to the output format, which are stored in the sample print table of the sample print information storage section 108, into the relevant portions so as to be updated (step 1108).

In the case that either the adding operation of the new sample print job, or the updating operation of the sample print job with respect to the sample print table of the sample print information storage section 108 is accomplished, the print server 100 notifies the above-explained sample print job acceptance information to the client 4 (step 1109), and then, the job producing section 107 produces such a print job that a total number of printed copies every output destination printer is equal to 1 from the output destination printer information, the output format, and the print data of the accepted sample print job (step 1110).

Then, the printer server 100 stores into the print data storage section 110, either of the accepted sample print job, or the print data of the print jobs which are produced every output destination printer in the step 1110 (step 1111). Since the accepted sample print job and the like are stored, in such a case that the user checks the result of the sample printing operation and then changes either the output format or the output destination printer while the final printing operation is carried out, the print job with respect to each of the respect output destination printers can be produced from the stored sample print jobs. As a result, when either the final printing operation or the resample-printing-operation is carried out, the print server 100 can produce the jobs in a flexible manner. Also, since the print jobs as to the respective output destination printers are stored, the print server 100 can quickly instruct the printing process operation when the final printing operation is carried out. The decision as to any one of the accepted sample print job and the print job every output destination printer is stored may be arbitrarily set in response to a storage capacity of the print data storage section 110.

Subsequently, the print server 100 transmits the print jobs which are produced in the step 1110 every output destination printer from the output section 104 to the respective printers (step 1112).

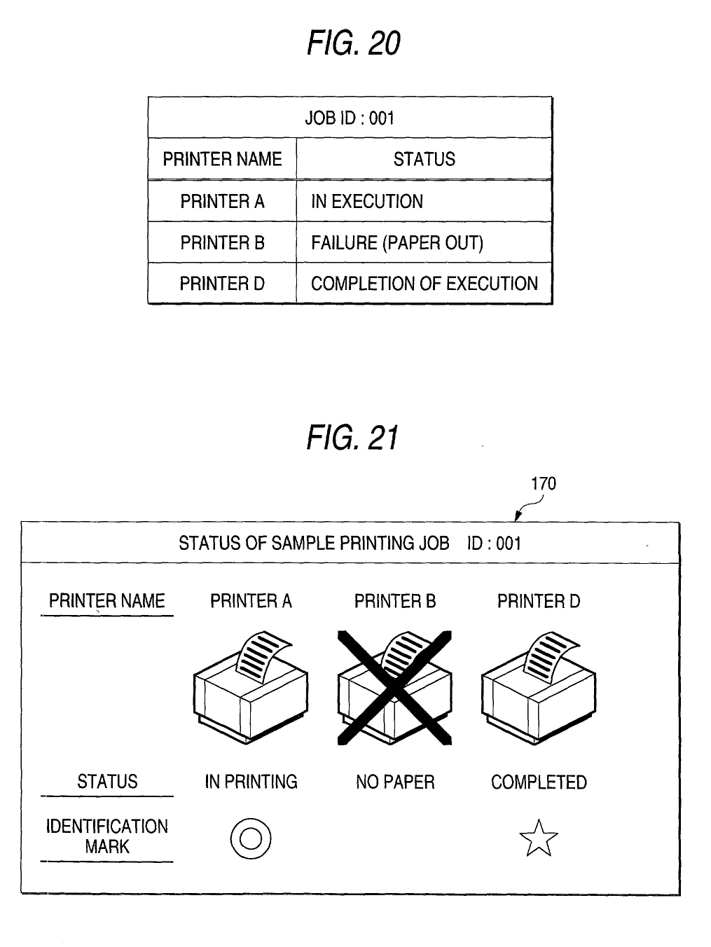

Thereafter, the printer condition managing section 109 of the print server 100 confirms the conditions of the respective printers and also the job process conditions at the respective output destination printers (step 1113). This confirmation is continued until all of these output destination printers have completed the job process operation (“NO” in step 1114). During this confirmation operation, the printer condition managing section 109 may interrogate the conditions of these printers in a periodic manner, or every time the conditions of these printers are changed, the respective printers may initiatively notify these changed conditions to the print server 100. Then, as indicated in FIG. 20, the job process conditions which have been acquired in the above manner with respect to these printers are managed in a print process condition management table which describes the respective printers and the conditions thereof associated with each other. The user can view the process condition of the sample print job on such a condition confirmation screen 170 as indicated in FIG. 21 by referring to the print process condition management table managed by the print server 100 from the client 4.

Also, when the printing process operations are accomplished in all of the output destination printers (“YES” in step 1114), the print server 100 notifies this fact to the client 4 (step 1115), and then, the process operation of this print server 100 is ended.

On the other hand, in such a case that both the information indicative of the sample printing information and the information representative of the final printing operation are added to the accepted print job (“YES” in step 1104), the print server 100 extracts the sample print job ID from this print job (step 1116), and further, reads out the print data stored in the print data storage section 110 based upon the extracted sample print job ID (step 1117).

Subsequently, the job producing section 107 produces such print jobs, which are transmitted to the respective output destination printers, from the accepted print job, the read print data, and also the information described in the trail print table of the sample print information storage section 109 (step 1118). In this case, the print server 100 calculates number of copies allocated to each of the output destination printers from a total number of output copies designated by the user, and the distribution output mode such as the “number-of-copies equal division” and the “same-printed-copies output.” Since the calculation method of these numbers of printed copies has already been described in the embodiment 1, explanations thereof are omitted in this embodiment 2.

Next, the print server 100 transmits the print jobs every output destination printer, which are produced in the step 1118, from the output section 104 to the respective printers (step 1119). Then, the printer condition managing section 109 of the print server 100 confirms the conditions of the respective printers and the job process conditions in the respective output destination printers (step 1120). This confirmation operation is continuously carried out until all of the respective output destination printers have accomplished the job processing operations (“NO” in step 1121). While this confirmation is carried out, the printer condition managing section 109 may queries the conditions to the respective printers in a periodic manner. Alternatively, each of these printers may initiatively notify the condition to the print server 100 every time the condition thereof is changed.

Thereafter, in the case that the printing process operations are accomplished in all of the output destination printers (“YES” in step 1121), the print server 100 deletes such an information relevant to the sample print job ID of the completed job from the sample print table of the sample print information storage section 108 (step 1122), and also deletes such a print data corresponding to the sample print job ID of the completed sample print job among the print data stored in the print data storage section 110 (step 1123). Then, the print server 100 notifies these deletions of the information and the print data to the client 4 (step 1124), and then, accomplishes this process operation.

It also is noted that in the above-described sample printing method, while the sample print table on which such an information related to the output destination printer instructed for the sample printing operation, and also the information related to the sample printing instruction such as the output format information are described is provided on the side of the print server 100, the data described in this sample print table is returned to the client 4 in response to the query issued from the client 4. However, the present invention is not limited only to this arrangement. Alternatively, another structure may be realized in which the sample print table is provided on the side of the client 4.

Also, in the job producing section 107 of the print server 100, which produces the sample print job every output destination printer, such different information as to the respective output destination printers may be added to the print data so as to produce the sample print jobs in order to discriminate that the print result of the sample printing operation is outputted from which printer.

Since the document processing system is arranged in the above-described manner, when the user compares the printed results obtained from the sample printing operations with each other, the user can easily confirm that the relevant printed result is outputted from which printer. Also, when the final printing operation is carried out, the user can easily eliminate the improper printer from all of the output destination printers, and can readily again set the output format to the specific printer in such a manner that the font and the color tone are corrected.

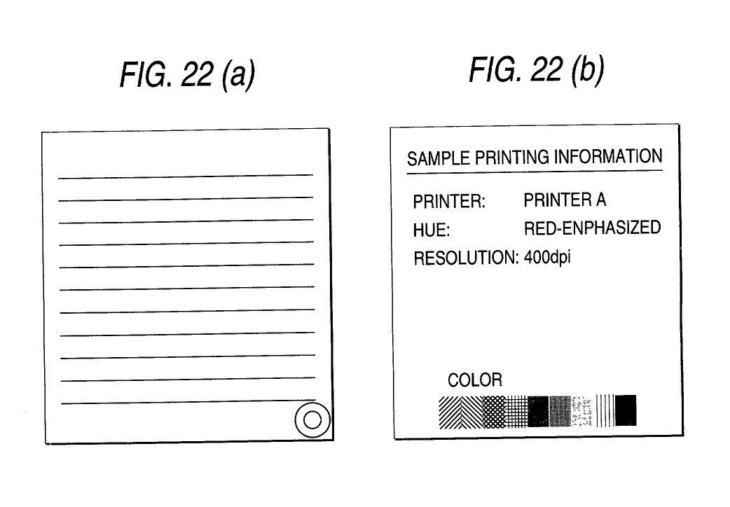

For example, as indicated in FIG. 22, such a print job may be produced in such a manner that a printer name, a location of a printer, and a symbol used to identify a printer are printed on a margin portion of paper to be printed. Also, information related to a sample printing operation may be printed on paper, and may be outputted in combination with a printed result. In this alternative case, large numbers of information may be described, as compared with such a case that the information related to the sample printing operation is printed on the margin. That is, all of such parameters set as the output formats may be described, both data related to a color characteristic of a printer and information of a font provided in this printer may be described, and data related to an optional structure of this printer may be described.

Alternatively, when the jobs are produced for the respective output destination printers by the print server 100, the above-described information related to the sample printing operation is not added, but such an information related to the sample printing operations may be added in the respective printers which accept the sample print jobs.

As previously described in detail, in accordance with the present invention, the document processing system is constituted in such a manner that while the print data contained in the accepted print job is temporarily stored in the spooler, when this print job is executed, a portion of the print data stored in this spooler is outputted as the sample printing operation, and also the remaining data thereof is outputted as the final printing operation in accordance with a predetermined condition. As a consequence, the user need not wait for the execution of various printing operations when the user instructs the printing operation, and also, instructs the final printing operation after the sample printing operation. Thus, the user can readily obtain the desirable printed results in accordance with the desirable printing qualities, and also the desirable number of the printed copies.

What is claimed is:

1. A print control apparatus for executing a print job and outputting the print job to at least one of a plurality of output destinations connected thereto through a network, the print control apparatus comprising:
job accepting means for accepting the print job;
temporary storage means for temporarily storing thereinto print data contained in the print job;
data converting means for converting the print data stored in the temporary storage means into output data corresponding to the output destination; and
output managing means for outputting a portion of data of the output data as first output data and for outputting at least the remaining data of the output data as second output data in accordance with a predetermined condition.

2. The print control apparatus according to claim 1, wherein the output managing means outputs the second output data at a previously designated time.

3. The print control apparatus according to claim 1, wherein the output managing means outputs the second output data at a time when a user instructs to output.

4. The print control apparatus according to claim 3, wherein the temporary storage means discards the print data when the user does not issue the data output instruction for a predetermined time duration.

5. The print control apparatus according to claim 1,
wherein the output managing means outputs the first output data to the output destination by user instruction and outputs the second output data to one of the other and same output destinations by user instruction; and
wherein the second data has the output destination independent of the first data.

6. The print control apparatus according to claim 5, wherein the output destination is one of a printing apparatus, a file, and a mail server.

7. The print control apparatus according to claim 1, further comprising print data combining means for combining a plurality of print data with each other, which are temporarily stored in the temporary storage means.

8. The print control apparatus according to claim 1, further comprising print data extracting means for extracting a portion of the print data which is temporarily stored in the temporary storage means.

9. The print control apparatus according to claim 1, further comprising print data editing means for replacing at least a portion of first print data contained in a first print job, which is temporarily stored in the temporary storage means, with at least a portion of second print data contained in a second print job.

10. A print instruction apparatus applied to a print system, connected via a network to a plurality of printers, the print instruction apparatus comprising:
number-of-output-copy accepting means for accepting an input of a number of output copy;
sample printing operation instructing means for instructing a plurality of printers to execute a sample printing operation; and
final printing operation instructing means for selecting a printer to instruct the selected printer to execute a final printing operation.

11. The print instruction apparatus according to claim 10, further comprising printer display means for displaying at least one printer, which the sample printing operation instructing means and the final printing operation instructing means can instruct to execute the printing operation.

12. The print instruction apparatus according to claim 11, wherein the printer display means displays the printer, which can be instructed to execute the printing operation, together with attribute information of the printer.

13. The print instruction apparatus according to claim 11,
wherein the printer display means comprises extract condition accepting means for accepting an input of a condition used to extract a printer; and
wherein the printer display means displays a printer extracted based upon the condition accepted by the extract condition accepting means.

14. The print instruction apparatus according to claim 10, wherein the final printing operation instructing means displays job identification information for identifying a print job executed in response to the sample printing instruction by the sample printing operation instructing means.

15. The print instruction apparatus according to claim 14, wherein the final printing operation instructing means selects a print job corresponding to the job identification information.

16. The print instruction apparatus according to claim 15, wherein the final printing operation instructing means displays printer information of a printer which is instructed to execute the printing operation by the print job corresponding to the job identification information.

17. The print instruction apparatus according to claim 16, wherein the printer information is information used to identify the respective printers.

18. The print instruction apparatus according to claim 16, wherein the printer information is condition information indicative of conditions of the respective printers.

19. A print control apparatus for executing a print control with respect to a plurality of printers connected to a network in accordance with a printing instruction issued from a client connected thereto via the network, the print control apparatus comprising:
sample printing job accepting means for accepting a sample printing instruction issued from the client with respect to the plurality of printers;
sample printing job producing means for producing print jobs to be processed in the printers designated by the sample printing instruction based on the sample printing instruction accepted by the sample job accepting means;
sample printing information managing means for storing thereinto one of the sample printing instruction accepted by the sample printing job accepting means and the plurality of the print jobs produced by the sample printing job producing means to manage the one; and
sample printing job requesting means for transmitting the plurality of print jobs produced by the sample print job producing means to the printers corresponding thereto.

20. The print control apparatus according to claim 19, further comprising sample printing job holding means for holding the print job requested by the sample printing job requesting means.

21. The print control apparatus according to claim 19, wherein the sample printing information managing means stores thereinto printer information of the printers designated by the sample printing instruction accepted by the sample printing job accepting means in combination with the one of the sample printing instruction and the print job.

22. The print control apparatus according to claim 19, further comprising sample printing information output means for outputting the one of the sample printing instruction and the print job, which is managed by the sample printing information managing means.

23. The print control apparatus according to claim 19,
wherein the sample printing job producing means produces print jobs to which identification information are added with respect to the plural printers, respectively; and
wherein the identification information is used to identify the printers designated by the sample printing instruction.

24. The print control apparatus according to claim 19, further comprising identification information outputting means for outputting identification information used to identify the printers connected to the network.

25. The print control apparatus according to claim 24, wherein the identification information is a printer name of the printer.

26. The print control apparatus according to claim 24, wherein the identification information is positional information of the printer.
